(19) United States
(12) Patent Application Publication
(10) Pub. No.: US 2007/0110652 A1
(43) Pub. Date: May 17, 2007

(54) Apparatus and method for removing ozone

(75) Inventors: Huey-Song You, Hsinchu (TW); Shu-Kang Hsu, Hsinchu City (TW); Shu-Fang Hsu, Hsinchu City (TW); Lien Tai Cho, Taichung City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/323,787

(22) Filed: Dec. 29, 2005

(30) Foreign Application Priority Data
Nov. 11, 2005 (TW) TW94139595

(51) Int. Cl. B01D 53/66; B01J 19/00

(52) U.S. Cl. 423/219; 422/129; 422/186; 422/168

(57) ABSTRACT

An apparatus for removing ozone. The apparatus includes a reaction tank containing a ferrous (Fe²⁺) solution to be oxidized to ferric ions (Fe³⁺) by ozone and a reduction device for reducing the ferric ions (Fe³⁺) to ferrous ions (Fe²⁺) supplied for continuous use in the reaction tank. The invention also provides a method for removing ozone.

### BACKGROUND OF THE INVENTION

1. Field of the Invention

The invention relates to environmental safety, and in particular to an apparatus and method for removing ozone.

2. Description of the Related Art

Currently, large quantities of ozone are used in panel display(photoelectron) or semiconductor fabrication to produce oxide layers or treat surfaces. Unfortunately, ozone can be harmful, even an extremely low concentration, due to its strong oxidation, corrosiveness, and low dissolvability. Thus, residual ozone in fabrications must be removed to ensure safety.

Current methods for removing ozone comprise decomposition using MnO₂ catalyst or UV irradiation, reduction by NaHSO₃, or dilution by addition of gases. These methods, however, are expensive and may cause low conversion efficiency, for example, limited material lifetime and high operating cost when using MnO₂ catalyst (heating is required) or with UV irradiation, expensive and non-recycled NaHSO₃ reagents, and ozone dilution by addition of gases without decrease in harmfulness.

### BRIEF SUMMARY OF INVENTION

The invention provides an apparatus for removing ozone, comprising a reaction tank containing a ferrous (Fe²⁺) solution to be oxidized to ferric ions (Fe³⁺) by ozone and a reduction device for reducing the ferric ions (Fe³⁺) to ferrous ions (Fe²⁺), supplied for continuous use in the reaction tank. The apparatus further comprises an acid control device, a stripping device, or a combination thereof.

Preferably, the reaction tank may be a packed tower, a tray tower, a scrubber, an ultracentrifuge (rotating packing bed), or an aeration tank/bottle, but is not limited thereto.

Preferably, the stripping device may be an aeration tank/bottle, a packed tower, a tray tower, or an ultracentrifuge, but is not limited thereto.

Preferably, the acid control device may be a wet scrubber, dry scrubber, or an adsorption bed, but is not limited thereto. The acid control device is used to remove acidic substances.

The invention also provides a method for removing ozone, comprising the following steps. An ozone-containing gas is conducted to a reaction tank containing a ferrous (Fe²⁺) solution to form ferric ions (Fe³⁺) by ozone. The ferric ions (Fe³⁺) are then reduced to ferrous ions (Fe²⁺) by a reduction device for continuous use in the reaction tank. The method provided by the invention further comprises acid separation, stripping, or a combination thereof.

In the invention, noxious ozone is reduced to harmless oxygen by contacting ferrous ions (Fe²⁺) therewith, thereby reducing corrosion in fabrication. Further, oxidized ferric ions (Fe³⁺) are reduced back to ferrous ions (Fe²⁺) to be recycled, significantly reducing the costs. Thus, ozone can be removed using a minimum of chemicals.

The apparatus and method for removing ozone is suitable for use in any industry producing ozone such as semiconductor, photoelectron, foodstuff, or glass substrate cleaning, but is not limited thereto.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIGS. 1˜4 show apparatuses for removing ozone of the invention; and

FIGS. 5˜8 show the results of ozone treatment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

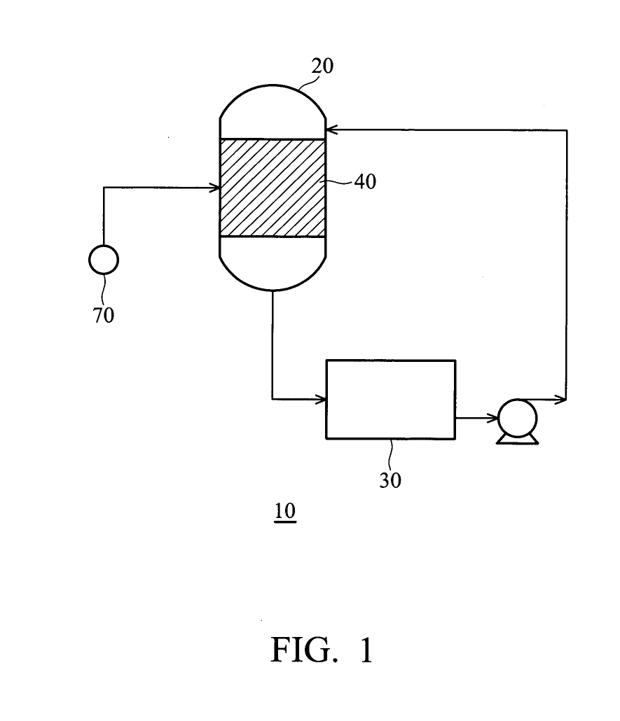

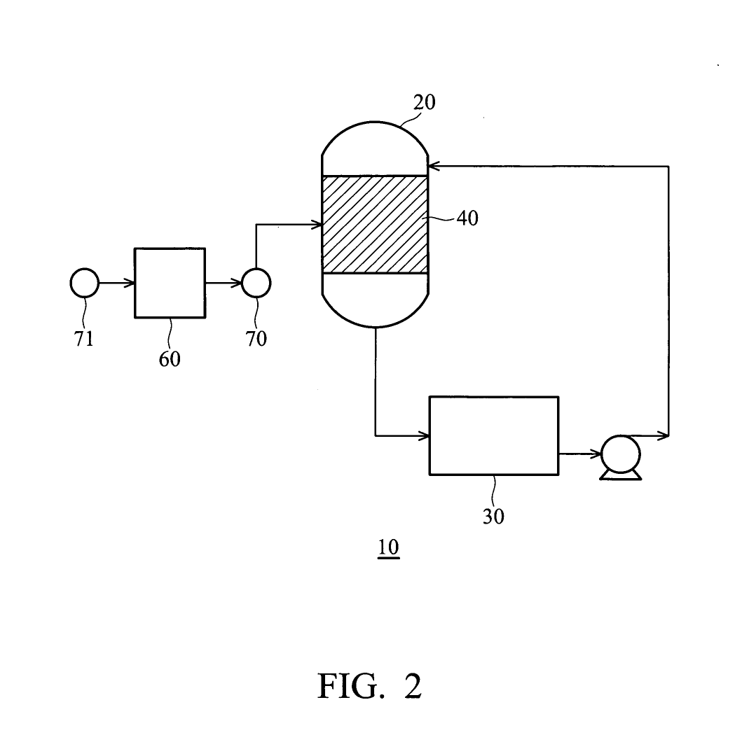

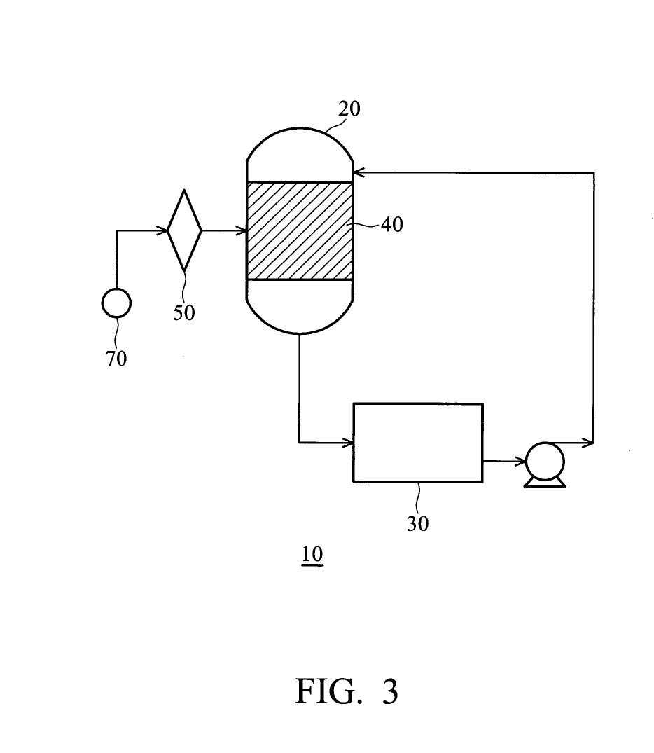

FIG. 1 shows an apparatus for removing ozone of the invention. The apparatus 10 comprises a reaction tank 20 containing a ferrous (Fe²⁺) solution 40 and a reduction device 30. In the reaction tank 20, the ferrous ions (Fe²⁺) are oxidized by flowing ozone-containing gas 70 to form ferric ions (Fe³⁺). The reduction device 30 then reduces the ferric ions (Fe³⁺) back to the ferrous ions (Fe²⁺) supplied for continuous use in the reaction tank 20.

The concentration of the ferrous solution 40 is altered as ozone concentration, for example, may be 200˜10,000 mg/l. The ozone-containing gas 70 may come from waste gas, waste liquid, or ozone water. Referring to FIG. 2, when the ozone-containing gas 70 comes from waste liquid or ozone water 71, the apparatus 10 may further comprise a stripping device 60 stripping ozone from liquid phase. The stripping device 60 may be an aeration tank/bottle, a packed tower, a tray tower, or an ultracentrifuge, depending on practical requirements, but is not limited thereto.

Referring to FIG. 3, the apparatus 10 may further comprise an acid control device 50 to remove organic or inorganic acidic substances from the ozone-containing gas 70, such as hydrofluoric acid, hydrochloric acid, nitric acid, sulfuric acid, or acetic acid. The acid control device 50 may be a wet scrubber, dry scrubber, or an adsorption bed, depending on practical requirements, but is not limited thereto. When the ozone-containing gas 70 comes from waste liquid or ozone water 71, the stripping device 60 and the acid control device 50 may be combined, as shown in FIG. 4.

The reaction tank 20 may be a packed tower, a tray tower, an ultracentrifuge, or an aeration tank, depending on practical requirements, but is not limited thereto. In addition, the reduction device 30 may be installed inside or outside the reaction tank 20, depending on factory building space. The reduction device 30 may be an electrolytic device such as Fenton device, depending on practical requirements, but is not limited thereto.

Referring to FIG. 3, a method for removing ozone of the invention is disclosed. The ozone-containing gas 70 is conducted to an acid control device 50 for removal of acidic substances such as hydrofluoric acid, hydrochloric acid, nitric acid, sulfuric acid, or acetic acid. Next, the acid-separated gas is conducted to the reaction tank 20 containing the ferrous (Fe²⁺) solution 40 to induce redox. The ferrous ions (Fe²⁺) are oxidized to ferric ions (Fe³⁺) and ozone is reduced to oxygen. The ferric ions (Fe³⁺) are then reduced to ferrous ions (Fe²⁺) by the reduction device 30 for continuous use in the reaction tank 20.

The flow rate of the ozone is about 0.1˜100,000 l/min. The redox is performed at about 4˜95° C. and at about 0.8˜1.2 atm. The invention provides an ozone reduction rate exceeding 85%. The pH of the ferrous solution 40 is about 0.5˜3.0.

The reduction device 30 provides reduction potential of about 3˜10V and reduction current density of about 20˜200 A/m². The redox may be performed inside or outside the reaction tank 20.

In the invention, corrosive ozone is converted to harmless oxygen by contacting ferrous ions (Fe²⁺) therewith. The oxidized ferric ions (Fe³⁺) are then reduced back to ferrous ions (Fe²⁺) by a simple electrolysis to be recycled, thus significantly reducing the costs and using a minimum of chemicals.

### EXAMPLE 1

Ozone treatments are performed in A and B factories, respectively. The treatment conditions are shown below.

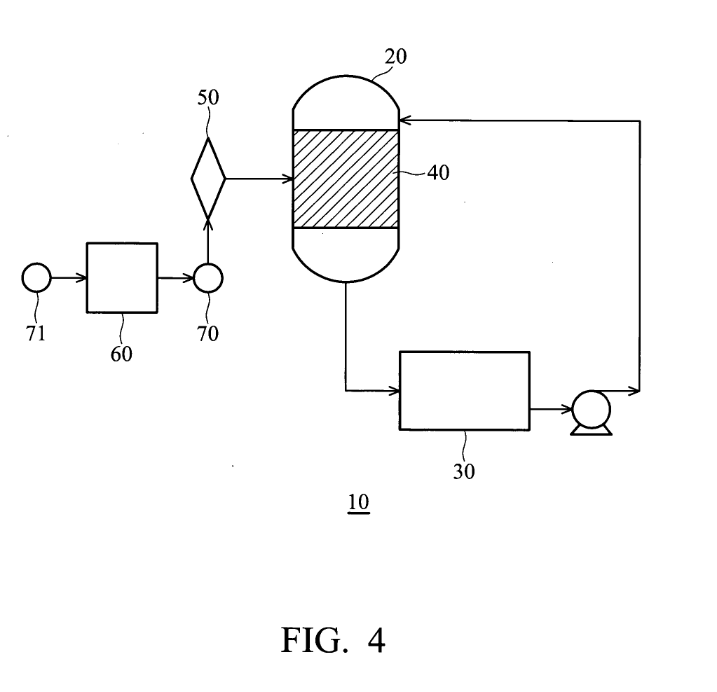

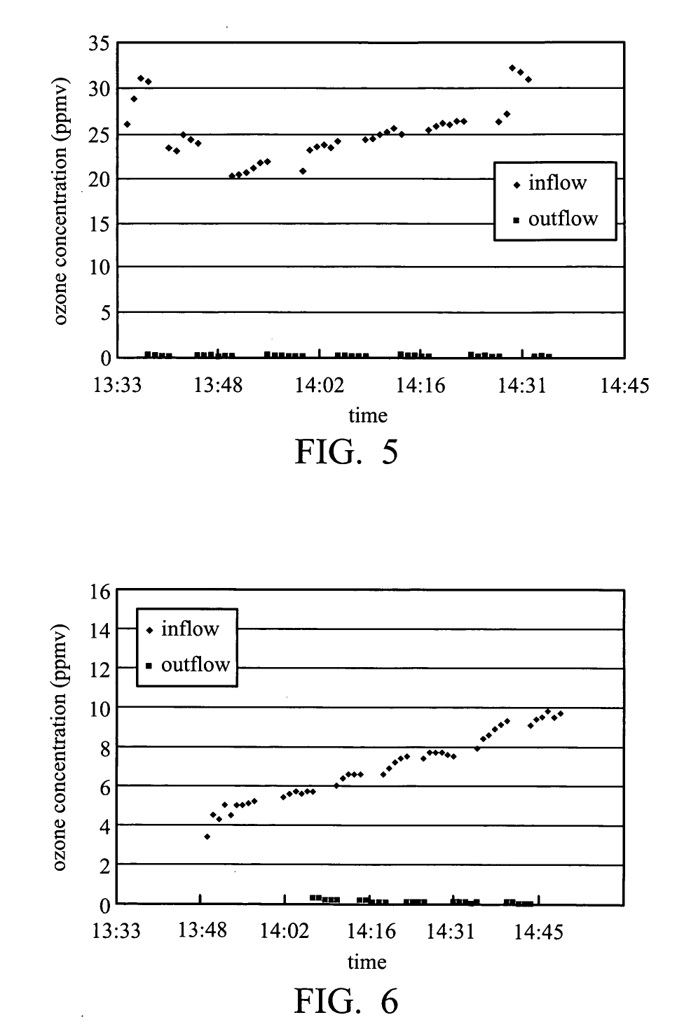

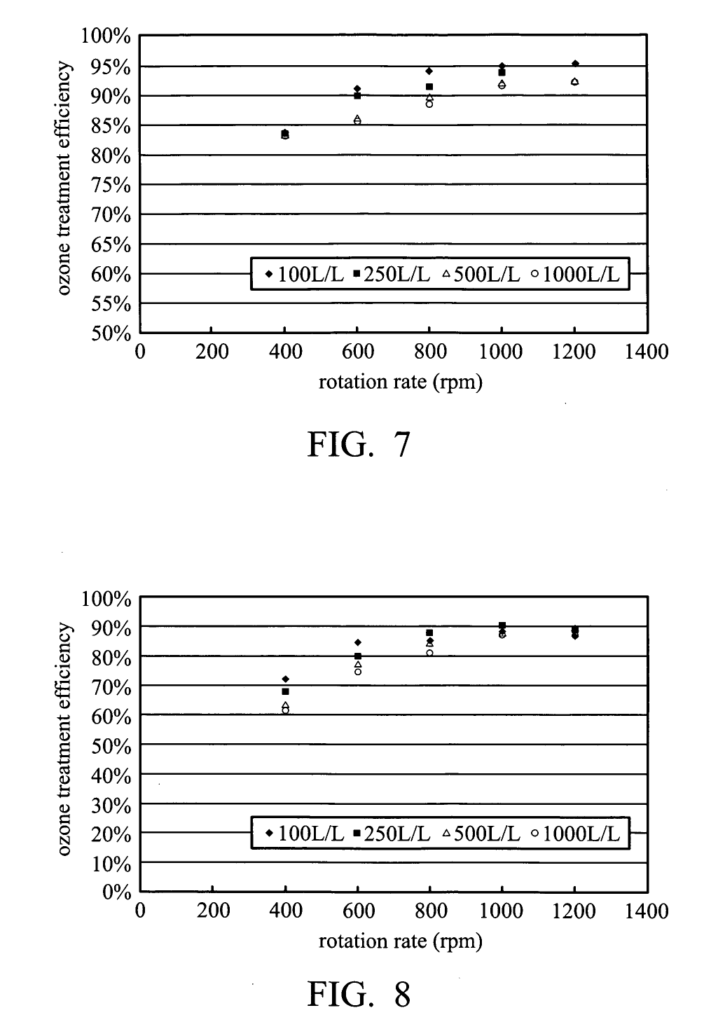

The flow rate of the ozone was 1.5 l/min, the volume of the ferrous solution was 600 ml, the concentration of the ferrous solution was 2500 mg/l, and the contact equipment was an aeration tank. The results are shown in FIGS. 5 (A factory) and 6 (B factory). The ozone reduction rates thereof exceed 95%.

### EXAMPLE 2

The contact equipment was a rotating packing bed. Ozone treatments were performed with various rotation rates and ferrous solution concentrations.

The concentration of the ferrous solution was 2,500 mg/l and 4000 mg/l, respectively, the rotation rates of the rotating packing bed were 400, 600, 800, 1,000, and 1,200 rpm, the gas/liquid ratios were 100, 250, 500, and 1,000 L/L, the gas retention time was 6.4 sec, and the ozone concentration was 100 ppmv. The results are shown in FIGS. 7 and 8. The ozone reduction rates thereof exceed 95.3%.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for removing ozone, comprising
a reaction tank containing a ferrous (Fe²⁺) solution to be oxidized to ferric ions (Fe³⁺) by ozone; and
a reduction device for reducing the ferric ions (Fe³⁺) to ferrous ions (Fe²⁺) supplied for continuous use in the reaction tank.

2. The apparatus as claimed in claim 1, wherein the ferrous solution has concentration between 200˜10,000 mg/l.

3. The apparatus as claimed in claim 1, wherein the ozone comes from waste gas or liquid.

4. The apparatus as claimed in claim 3, wherein the waste gas or liquid further comprises organic or inorganic acidic substances.

5. The apparatus as claimed in claim 4, further comprising an acid control device for removing the acidic substances of the waste gas.

6. The apparatus as claimed in claim 3, further comprising a stripping device for stripping the ozone from the waste liquid.

7. The apparatus as claimed in claim 1, wherein the reaction tank comprises packed towers, tray towers, ultracentrifuges, or aeration tanks.

8. The apparatus as claimed in claim 1, wherein the reduction device is installed inside the reaction tank.

9. The apparatus as claimed in claim 1, wherein the reduction device is installed outside the reaction tank.

10. The apparatus as claimed in claim 1, wherein the reduction device is an electrolytic device.

11. The apparatus as claimed in claim 1, wherein the ferrous solution has pH of about 0.5˜3.0.

12. A method for removing ozone, comprising
conducting an ozone-containing gas to a reaction tank containing a ferrous (Fe²⁺) solution to form ferric ions (Fe³⁺) by ozone; and reducing the ferric ions (Fe³⁺) to ferrous ions (Fe²⁺) by a reduction device to supplied for continuous use in the reaction tank.

13. The method as claimed in claim 12, wherein the ferrous solution has concentration between 200-10,000 mg/l.

14. The method as claimed in claim 12, wherein the ozone comes from waste gas or liquid.

15. The method as claimed in claim 14, wherein the waste gas or liquid further comprises organic or inorganic acidic substances.

16. The method as claimed in claim 15, further comprising removing the acidic substances of the waste gas before the waste gas is conducted to the reaction tank.

17. The method as claimed in claim 14, further comprising stripping the ozone from the waste liquid.

18. The method as claimed in claim 12, wherein the ozone has a flow rate of about 0.1˜100,000 l/min.

19. The method as claimed in claim 12, wherein the redox is performed with a temperature of about 4˜95° C.

20. The method as claimed in claim 12, wherein the redox is performed with a pressure of about 0.8˜1.2 atm.

21. The method as claimed in claim 12, wherein the reduction device provides a reduction potential of about 3˜10V.

22. The method as claimed in claim 12, wherein the reduction device provides a reduction current density of about 20˜200 A/m².

23. The method as claimed in claim 12, wherein the ferrous solution has pH of about 0.5˜3.0.
